(19) United States
(12) Patent Application Publication
(10) Pub. No.: US 2009/0059050 A1
(43) Pub. Date: Mar. 5, 2009

(54) IMAGING APPARATUS AND DRIVING METHOD OF CCD TYPE SOLID-STATE IMAGING DEVICE

(76) Inventor: Tomohiro SAKAMOTO, Miyagi (JP)

Correspondence Address: BIRCH STEWART KOLASCH & BIRCH, PO BOX 747, FALLS CHURCH, VA, 22040-0747, US

(21) Appl. No.: 12/198,472

(22) Filed: Aug. 26, 2008

(30) Foreign Application Priority Data
Aug. 27, 2007 (JP) P2007-219893

(51) Int. Cl. H04N 5/335

(52) U.S. Cl. 348/311; 348/E05.091

(57) ABSTRACT

There is provided a driving method of a CCD solid-state imaging device that includes: a first pixel group including pixels arranged in a square lattice; a second pixel group including pixels shifted in a row direction and a column direction of the square lattice by 2/1 of a pixel pitch with respect to the pixels in the first pixel group; color filters arranged in Bayer array with respect to each of the first pixel group and the second pixel group; vertical transfer paths; a horizontal charge transfer path; and a line memory. The method includes adding signal charges, which are detected in two same color pixels adjacent in a horizontal direction in the first pixel group, in the horizontal charge transfer path and outputting the added signal charges, by means of a four-phase drive pulse of the horizontal charge transfer path and a drive pulse of the line memory.

This application is based on and claims priority under 35 U.S.C. §119 from Japanese Patent Application No. 2007-219893 filed Aug. 27, 2007, the entire disclosure of which is herein incorporated by reference.

### BACKGROUND OF THE INVENTION

1. Field of the Invention

The present invention relates to an imaging apparatus including a CCD (Charge Coupled Device) type solid-state imaging device, and particularly to a driving method of the CCD type solid-state imaging device.

2. Description of Related Art

As an array pattern of color filters stacked on respective pixels of a solid-state imaging device, there is a Bayer array. This Bayer array is constituted, as shown on an upper part in FIG. 6, so that: when three-primary-color type color filters of red (R, r), green (G, g), and blue (B, b) are arranged on pixels (photoelectric conversion element: photodiode) formed in a square lattice shape in a surface part of a semiconductor substrate, a row in which each red filter and each green filter are arranged alternately and a row in which each green filter and each blue filter are arranged alternately are arranged alternately in a column direction.

On the basis of this Bayer array, in a CCD type solid-state imaging device described in JP-A-2004-55786, a first pixel group (upper part left side in FIG. 6) in which the color filters are arranged according to the Bayer array, and a second pixel group (upper part right side in FIG. 6) in which the color filters are arranged according to the Bayer array are mixed as shown in a lower part in FIG. 6. The first pixel group and the second pixel group are disposed in positions shifted in each of the row direction and in the column direction by 1/2 of a pixel pitch.

Further, also in a CMOS type solid-state imaging device described in JP-A-2007-124137, a first pixel group of the Bayer array, and a second pixel group of the Bayer array are mixed so as to be disposed in positions shifted in each of the row direction and in the column direction by 1/2 of a pixel pitch.

According to the CMOS type solid-state imaging device described in JP-A-2007-124137, a signal detected by each pixel can be arbitrarily read out. Therefore, even in a solid-state imaging device having a double arrangement structure of the Bayer array as above-described, additional reading (pixel mixture) of the detected signals of the respective pixels can be readily performed.

However, in a CCD type solid-state imaging device, a signal detected by each pixel (signal charge) should be transferred along a vertical charge transfer path (VCCD) and next transferred along a horizontal charge transfer path (HCCD). Therefore, the CCD type solid-state imaging device has restriction that detected signals of the respective pixels should be read out in a specific order, so that the pixel mixture is not easy.

JP-A-2006-157624 proposes a structure that a buffer part of signal charge, called a line memory, is provided at a connection part between each vertical charge transfer path and the horizontal charge transfer path, thereby to perform pixel mixture of pixels adjacent in the horizontal direction by cooperation of this line memory and the horizontal charge transfer path.

However, even in case that pixel addition in the horizontal direction is performed by a CCD type solid-state imaging device having a line memory, when the color filter arrangement of this CCD type solid-state imaging device is the double arrangement structure of Bayer array as described in the lower part in FIG. 6, it is not clear which method of driving the solid-state imaging device should be adopted to perform the pixel addition at an appropriate and high frame rate.

### SUMMARY OF THE INVENTION

An object of the invention is to provide, in a CCD type solid-state imaging device having A double arrangement structure of Bayer array, a driving method of the CCD type solid-state imaging device and an imaging apparatus, in which good pixel addition can be performed.

According to an aspect of the invention, there is provided a method for driving a CCD solid-state imaging device that includes: a semiconductor substrate; a first pixel group including a plurality of pixels arranged in a square lattice in a surface part of the semiconductor substrate; a second pixel group including a plurality of pixels shifted in each of a row direction and a column direction of the square lattice by 2/1 of a pixel pitch with respect to the pixels in the first pixel group; color filters arranged in Bayer array with respect to each of the first pixel group and the second pixel group; a plurality of vertical transfer paths disposed in a serpentine way along pixel arrays, each pixel array including a plurality of pixels in the first pixel group and a plurality of pixels in the second pixel group; a horizontal charge transfer path disposed along ends in a charge transfer direction of the plurality of vertical transfer paths; and a line memory which is disposed between the ends in the charge transfer direction of the plurality of vertical transfer paths and the horizontal charge transfer path and which temporarily retains signal charges transferred by each of the plurality of vertical charge transfer paths and transfers the signal charges to the horizontal charge transfer path, the method comprising adding signal charges, which are detected in two pixels in the first pixel group, in the horizontal charge transfer path and outputting the added signal charges, by means of a four-phase drive pulse of the horizontal charge transfer path and a drive pulse of the line memory, wherein the two pixels in the first pixel group are adjacent in a horizontal direction and correspond to color filters having the same color.

In the method, signal charges in the second pixel group may be discarded.

Alternatively, the method may further comprise adding signal charges, which are detected two pixels in the second pixel group, in the horizontal charge transfer path and outputting the added signal charges, by means of the four-phase drive pulse of the horizontal charge transfer path and the drive pulse of the line memory, wherein the two pixels in the second pixel group are adjacent in the horizontal direction and correspond to color filters having the same color.

According to an aspect of the invention, there is provided an imaging apparatus comprising: a CCD solid-state imaging device that includes: a semiconductor substrate; a first pixel group including a plurality of pixels arranged in a square lattice in a surface part of the semiconductor substrate; a second pixel group including a plurality of pixels shifted in each of a row direction and a column direction of the square lattice by 2/1 of a pixel pitch with respect to the pixels in the first pixel group; color filters arranged in Bayer array with respect to each of the first pixel group and the second pixel group; a plurality of vertical transfer paths disposed in a serpentine way along pixel arrays, each pixel array including a plurality of pixels in the first pixel group and a plurality of pixels in the second pixel group; a horizontal charge transfer path disposed along ends in a charge transfer direction of the plurality of vertical transfer paths; and a line memory which is disposed between the ends in the charge transfer direction of the plurality of vertical transfer paths and the horizontal charge transfer path and which temporarily retains signal charges transferred by each of the plurality of vertical charge transfer paths and transfers the signal charges to the horizontal charge transfer path; and a drive section that drives the CCD solid-state imaging device so that signal charges detected two pixels in the first pixel group are added in the horizontal charge transfer path and outputted, by means of a four-phase drive pulse of the horizontal charge transfer path and a drive pulse of the line memory, wherein the two pixels in the first pixel group are adjacent in a horizontal direction and correspond to color filters having the same color.

In the imaging apparatus, signal charges in the second pixel group may be discarded.

Alternatively, in the imaging apparatus, a drive section may drive the CCD solid-state imaging device so that: signal charges detected two pixels in the first pixel group are added in the horizontal charge transfer path and outputted, by means of a four-phase drive pulse of the horizontal charge transfer path and a drive pulse of the line memory, wherein the two pixels in the first pixel group are adjacent in a horizontal direction and correspond to color filters having the same color; and signal charges detected two pixels in the second pixel group are added in the horizontal charge transfer path and outputted, by means of the four-phase drive pulse of the horizontal charge transfer path and the drive pulse of the line memory, wherein the two pixels in the second pixel group are adjacent in the horizontal direction and correspond to color filters having the same color.

### BRIEF DESCRIPTION OF THE DRAWINGS

The features of the invention will appear more fully upon consideration of the exemplary embodiments of the inventions, which are schematically set forth in the drawings, in which:

FIG. 1 is a functional block diagram of a digital camera according to an exemplary embodiment of the invention;

FIG. 2 is an exemplary surface view of a CCD type solid-state imaging device shown in FIG. 1;

FIG. 3 is a connection diagram of horizontal transfer electrodes of the CCD type solid-state imaging device shown in FIG. 2;

FIG. 4 is an explanatory diagram of a pixel addition drive method according to an exemplary embodiment of the invention;

FIG. 5 is an explanatory diagram of a pixel addition drive method according to another exemplary embodiment of the invention; and

FIG. 6 is an explanatory diagram of a double arrangement structure of Bayer array.

### DETAILED DESCRIPTION OF THE EXEMPLARY EMBODIMENTS

According to an exemplary embodiment of the invention, pixel addition from a CCD type solid-state imaging device in which the color filter arrangement has a double arrangement structure of Bayer array can be readily and accurately performed at a high frame rate thereby to read out the signals, so that high-sensitivity imaging and moving imaging can become easy.

An exemplary embodiment of the invention will be described below with reference to drawings.

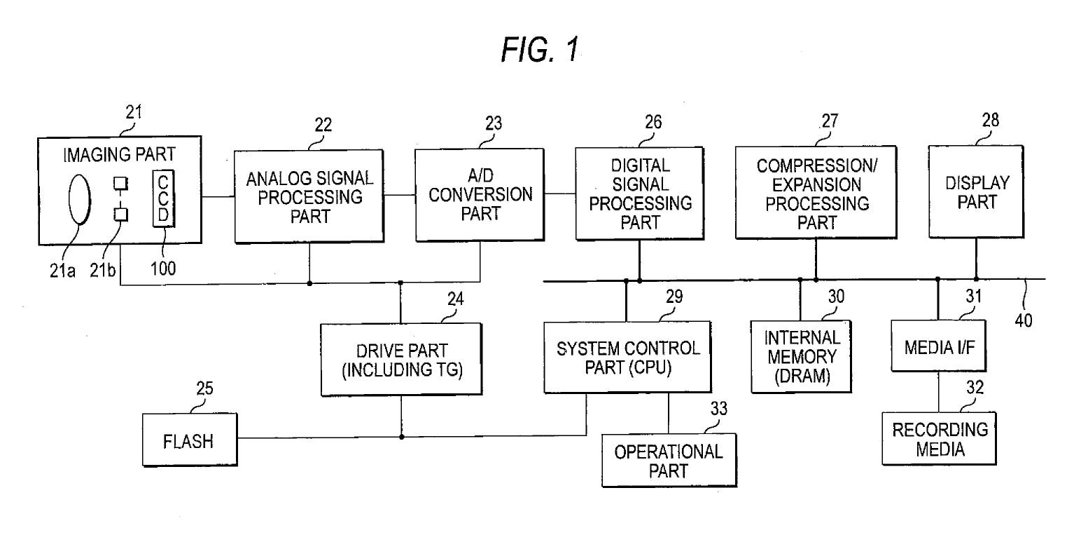

FIG. 1 is a functional block diagram of a digital camera according to an exemplary embodiment of the invention. This digital camera includes an imaging part 21; an analog signal processing part 22 which subjects analog image data outputted from the imaging part 21 to analog processing such as automatic gain control (AGC) and correlated double sampling (CDS); an analog/digital conversion part (A/D) 23 which converts analog image data outputted from analog signal processing part 22 into digital image data; a drive part (including a timing generator GT) 24 which performs drive control of the A/D 23, the analog signal processing part 22, and the imaging part 21 on the basis of an instruction from a system control part (CPU) 29 described later; and a flash 25 which emits light on the basis of an instruction from the CPU 29.

The imaging part 21 includes an optical lens system 21a which collects light from a subject scene; an aperture diaphragm or a mechanical shutter 21b which narrows the light passing through the optical lens system 21a; and a single-chip solid-state imaging device 100 for color imaging which receives the light collected by the optical lens system 21a and narrowed by the diaphragm and outputs taken image data (analog image data).

The digital camera in this embodiment includes further a digital signal processing part 26 which captures the digital image data outputted from the A/D 23 to perform interpolation processing, white balance control, and RGB/YC conversion processing; a compression/expansion processing 27 which compresses the image data into JPEG image data or expands the image data to the contrary; a display part 28 which displays a menu or displays a through image or a taken image; a system control part (CPU) 29 which controls generally the entirety of the digital camera; an internal memory 30 such as a frame memory; a media interface (I/F) part 31 which performs interface processing with a recording media 32 which stores the JPEG image data therein; and a bus 40 which interconnects them. Further, to the system control part 29, an operational part 33 for inputting an instruction from a user is connected.

In this embodiment, according to whether an taking instruction from the user operational part 33 is a taking instruction of still image or a taking instruction of moving image, the CPU 29 judges whether the taken image data are output from the solid-state imaging device 100 without pixel mixture, or whether the taken image data are output from the solid-state imaging device 100 after pixel mixture. The drive part 24 performs drive control of the solid-state imaging device 100 on the basis of the instruction from the CPU 29.

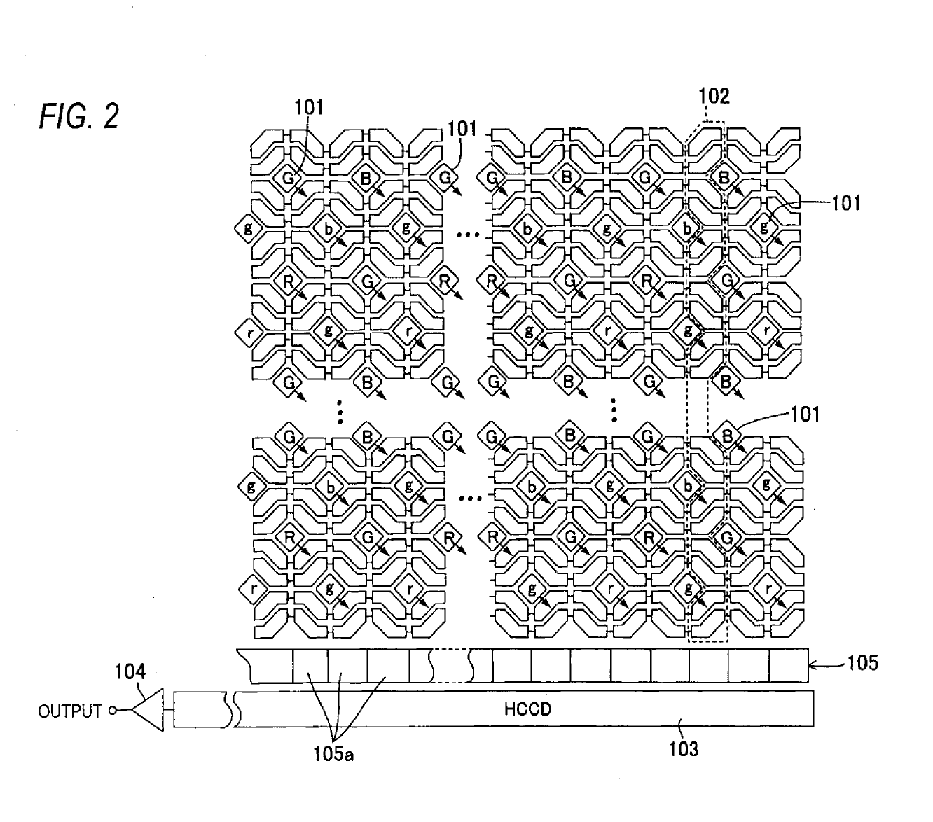

FIG. 2 is an exemplary surface view of the solid-state imaging device 100. The digital camera in this embodiment uses, as the solid-state imaging device 100, a CCD type solid-state imaging device of a so-called honeycomb pixel array.

In the surface part of a semiconductor substrate, plural photoelectric converters (photo diodes PD: hereinafter referred to as pixels) 101 are arranged in a two-dimensional array, and the pixels in the even-numbered lines are displaced by 1/2 of a pixel pitch with respect to the pixels in the odd-numbered lines.

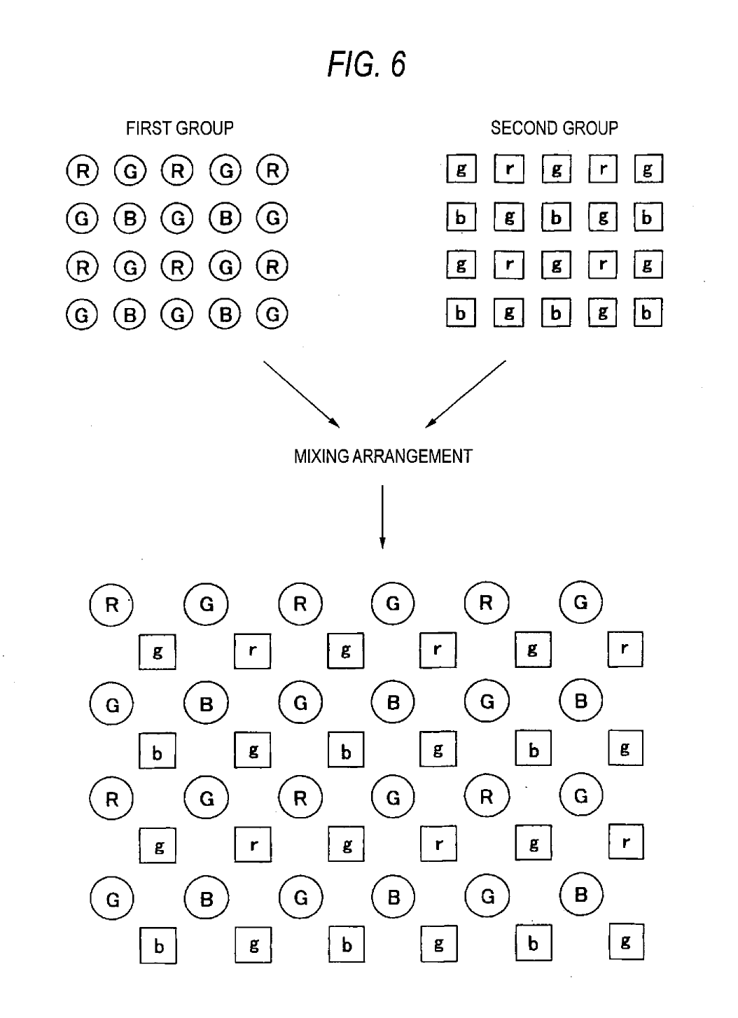

Seeing only the pixels (first pixel group) in the even-numbered lines (or in the odd-numbered lines), the respective pixels photoelectric converters) are arranged in a square lattice, and color filters (R=red, G=green, and B=blue) are arranged in the Bayer array with respect to this square lattice arrangement. Further, seeing only the pixels (second pixel group) in the odd-numbered lines (or in the even-numbered lines), the respective pixels are arranged in a square lattice, and color filters are arranged in the Bayer array with respect to this square lattice arrangement. As a whole, the color filter arrangement has a double arrangement structure of Bayer array as shown in the lower part in FIG. 6.

Here, a red signal, a green signal, and a blue signal which are signals detected in the first pixel group are denoted by capital letters R, G, and B; and a red signal, a green signal, and a blue signal which are detected in the second pixel group are denoted by small letters r, g, and b thereby to show and explain them in distinction.

In this embodiment, first pixel group and the second pixel group are the same in the light receiving area of each pixel and size of a microlens (not shown) thereof, so that there is no difference between the first and second pixel groups. However, as described in JP-A-2004-55786, the first pixel group may be high sensitive pixels each having a larger area, and the second pixel group may be low sensitive pixels each having a smaller area.

Along each pixel column, a vertical charge transfer path (VCCD) 102 is formed in a serpentine way so as to avoid each pixel 101, a horizontal charge transfer path (HCCD) 103 is provided along the end in the transfer direction of each vertical charge transfer path 102, and an amplifier 104 which outputs a voltage signal according to the amount of the transferred charges as imaging data is provided at an output part of the horizontal charge transfer path 103.

In the CCD type solid-state imaging device 100 in this embodiment, similarly to the case in JP-A-2006-157624, a line memory (LM) 105 is provided between the end in the transfer direction of each vertical charge transfer path 102 and the horizontal charge transfer path 103 so that pixel mixture in the horizontal direction is readily performed.

The line memory 105 includes, for each vertical charge transfer path 102, a buffer area 105a for temporarily storing the signal charge received from the corresponding vertical charge transfer path 102. In accordance with combination of a line memory drive pulse φLM and a horizontal transfer pulse φH from the drive part 24 shown in FIG. 1, timing in which the charge stored in each buffer area 105a is transferred to the horizontal charge transfer path 103 is controlled.

The terms “horizontal” and “vertical” are used for explanation, but simply mean the “one direction” and “direction substantially perpendicular to the one direction” in the surface part of the semiconductor substrate.

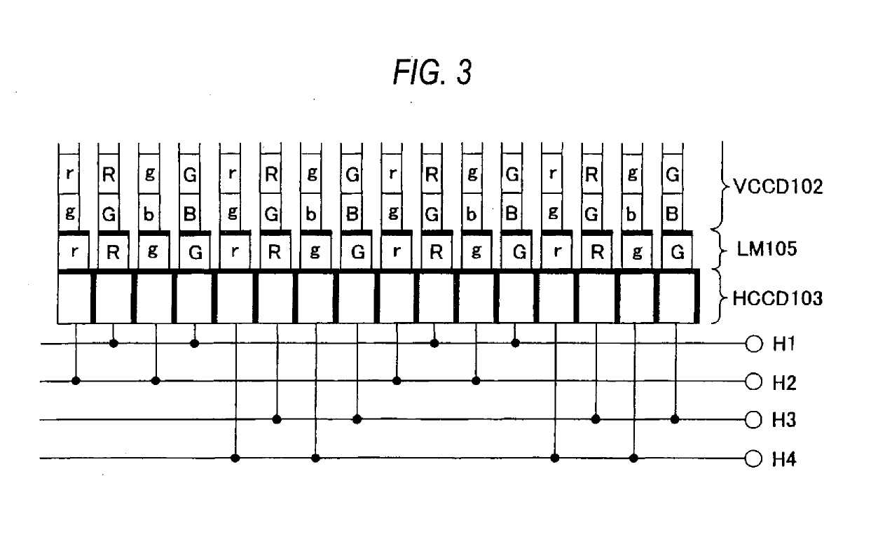

FIG. 3 shows electrode wiring of the horizontal charge transfer path (HCCD) 103. In order to perform the pixel mixture, the horizontal charge transfer path 103 in this embodiment is driven by horizontal transfer pulses of four phases (φH1 to φH4), and line memory (LM) drive pulses are combined with these horizontal transfer pulses, whereby the pixel mixture is performed.

A horizontal transfer electrode to which a horizontal transfer pulse Hi (i=1 to 4) is applied is called an electrode Hi. Namely, the horizontal transfer electrode in this embodiment is constituted by four-phase drive electrodes in order of H2, H1, H2, H1, H4, H3, H4, H3, . . . from the output amplifier side.

Characters R, G, B, r, g, and b described on the line memory (LM) 105 and the vertical charge transfer path 102 shown in FIG. 3 show respectively signal charges read out from the respective pixels 101 (R-pixel mounted with a color filter R, . . . and b-pixel mounted with a color filter b) shown in FIG. 2 and transferred. Pixel rows of every two rows from the downside shown in FIG. 2 are transferred to the line memory (LM) 105 as signal charges of a line unit and temporarily stored therein.

Namely, when each signal charge of the R-pixel, C-pixel, and B-pixel is read out by the vertical charge transfer path 102, and the signal charges are transferred are transferred in the vertical direction by the vertical transfer electrodes of the two columns, in case that each signal charge of the r-pixel, g-pixel, and b-pixel is read out by the vertical charge transfer path 102, line data of rRgGrRgG . . . and line data of gGbBgGbB . . . come being alternately transferred from the vertical charge transfer path 102 to the line memory 105.

When the user inputs an instruction of a high-accurate still image taking mode from the operational part 33 to such the digital camera, the CPU 29 controls the drive part 24 and drives the CCD type solid-state imaging device 100 at the high-accurate still image taking mode.

Namely, as shown in FIG. 3, when the signal charges rRgGrRgG . . . (or gGbBgGbB . . . ) from the respective pixels are transferred to and retained in the line memory 105, the drive pulse of the line memory 105 is put in the L-level (low level) and the horizontal electrodes H2 and H4 are put in the H-level high level).

Hereby, the respective signal charges in the positions corresponding to the electrodes H2 and H4 on the line memory 105 are moved into deep potential wells formed under the electrodes H2 and H4. Thereafter, the drive pulse of the line memory 105 is returned to the H-level, and the horizontal charge transfer path 103 is driven, thereby to output the voltage signal of each signal charge from the amplifier 104.

Next, the drive pulse of the line memory 105 is put in the L-level and the horizontal electrodes H1 and H3 are put in the H-level. Hereby, the signal charges remaining in the line memory 105 move to the horizontal charge transfer path, and the horizontal charge transfer path is driven, thereby to output the voltage signal according to the charge amount of each signal charge from the amplifier 104.

The digital signal processing part 26 in FIG. 1, on the basis of the detection signals of the respective pixels shown in FIG. 2, generates a high-accurate still image.

When the user inputs an instruction of a moving image taking mode from the operational part 33, the CPU 29 controls the drive part 24 and drives the CCD type solid-state imaging device 100 at the moving image taking mode.

In this case, in the digital camera in this embodiment only the signals detected by the R-pixel, the G-pixel, and the B-pixel in the first pixel group shown in FIG. 6 are output from the solid-state imaging device 100; and pixel additions of the R-pixels adjacent in the horizontal direction, the G-pixels adjacent in the horizontal direction, and the B-pixels adjacent in the horizontal direction are performed and the added pixels are output. The signals detected by the r-pixel, the g-pixel, and the b-pixel in the second pixel group are discarded.

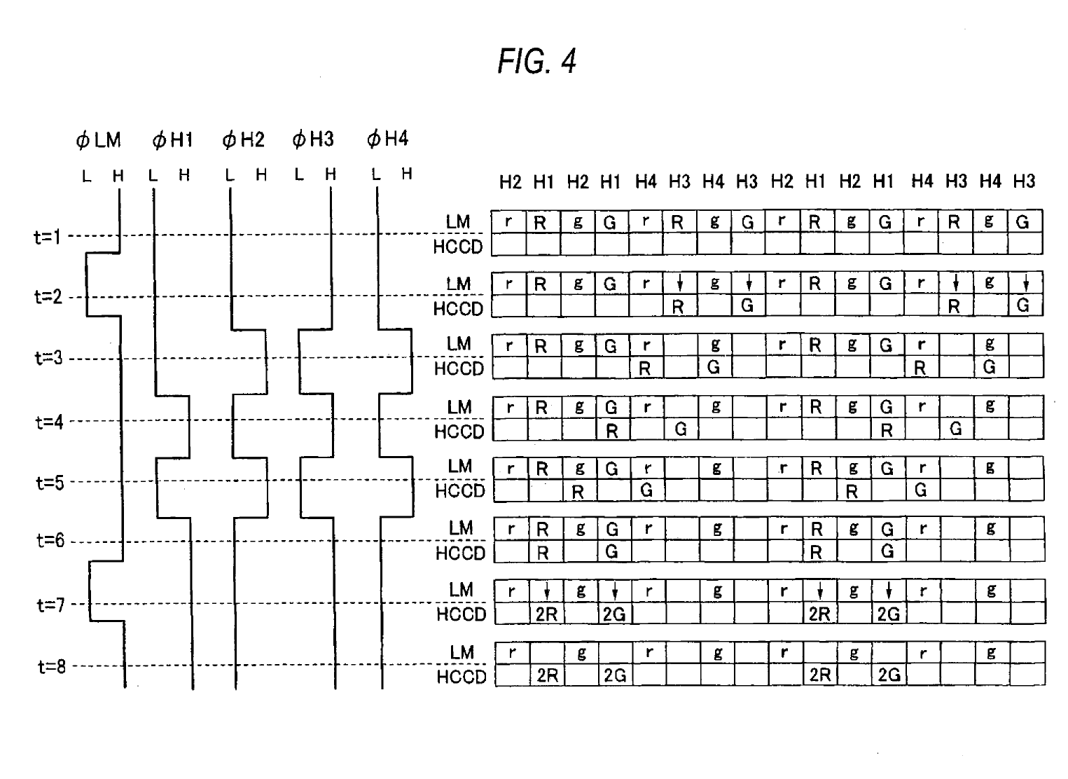

FIG. 4 shows a pixel addition drive method of the R-pixel, the G-pixel and the B-pixel which constitute the first pixel group. At the time t=1, the signal charges rRgG . . . from the respective pixels are transferred to and retained in the line memory 105 similarly to the aforementioned. At this time t=1, only the transfer pulse φH3 of the horizontal transfer electrode H3 is put in the H-level, and the transfer pulses of the other electrodes H1, H2 and H4 are put in the L-level.

At the next time t=2, the drive pulse φLM of the line memory 105 becomes the L-level. Hereby, the electric potential of the line memory 105 becomes high, but the electric potentials of the horizontal electrodes H1, H2 and H4 remain high. Therefore, the movement of the signal charge is not produced from the line memory 105 to the potential wells under the horizontal transfer electrodes H1, H2 and H4.

However, since the horizontal transfer pulse φH3 of the H-level is applied to the horizontal transfer electrode H3, of which the potential well is deep, the signal charge of the R-pixel and the signal charge of the G-pixel are moved from the buffer areas 105a of the line memory 105, which are opposed to the positions of the horizontal transfer electrodes H3, to the horizontal charge transfer path 103 as shown in FIG. 4.

At the next time t=3, when the horizontal transfer pulses are changed as follows: φH1:L→L, φH2:L→H, φH3:H→L, and φH4:L→H, the charges on the horizontal charge transfer path 103 are transferred to the output amplifier side (left direction in FIG. 4) by only one electrode.

At the next time t=4, when the horizontal transfer pulses are changed as follows: φH1: L→H, φH2: H→L, φH3: L→H, and φH4: H→L, the charges are further transferred to the output amplifier side by one electrode.

Similarly, at the next time t=5, when the horizontal transfer pulses are changed as follows: φH1: H→L, φH2: L→H, φH3: H→L, and φH4: L→H, the charges are further transferred to the output amplifier side by one electrode.

Further, at the next time t=6, when the horizontal transfer pulses are changed as follows: φH1: L→H, φH2: H→L, φH3: L→H, and φH4: H→L, the charges are further transferred to the output amplifier side by one electrode.

In the CCD type solid-state imaging device having the color filter arrangement having the double structure of Bayer array described in the lower part of FIG. 6 and in FIG. 2, by the transfer up to the time t=6 in FIG. 4, the R-signal charge (R-pixel signal charge) and the G-signal charge (G-pixel signal charge) come just into the potential wells under the electrodes H1.

Since the R-signal charge and the G-signal charge are retained in the line memory 105 at the positions opposed to the horizontal transfer electrodes H1, when the drive pulse of the line memory 105 changes from H to L at the next time t=7, the R-signal charge and the G-signal charge on this line memory 105 move respectively to the horizontal charge transfer path. Hereby, in the horizontal charge transfer path, the R-pixels adjacent in the horizontal direction, and the G-pixels adjacent in the horizontal direction are respectively subjected to pixel addition of signal charge.

Thereafter, when the horizontal charge transfer path 103 is driven, the signal charges of 2R and 2G are output from the output amplifier as voltage signals, and the signal charges of the r-pixel and the g-pixel and the b-pixel remain on the line memory 105. The remaining r, g, and b signal charges are collectively moved to the horizontal charge transfer path in a lump after completion of output of the 2R and 2G signal charges, and they can be swept by high-speed sweep drive of the horizontal charge transfer path.

By the transfer drive of the next vertical charge transfer path, the signal charges of gGbBgGbB . . . are transferred to the line memory 105. By the drive control similar to that in FIG. 4, the 2G signal addition and the 2B signal addition are performed on the horizontal charge transfer path, and the added signals are outputted. The digital signal processing part 26 in FIG. 1 generates moving image data of a subject to be taken from the signals of 2R, 2G and 2B added and read out as described above.

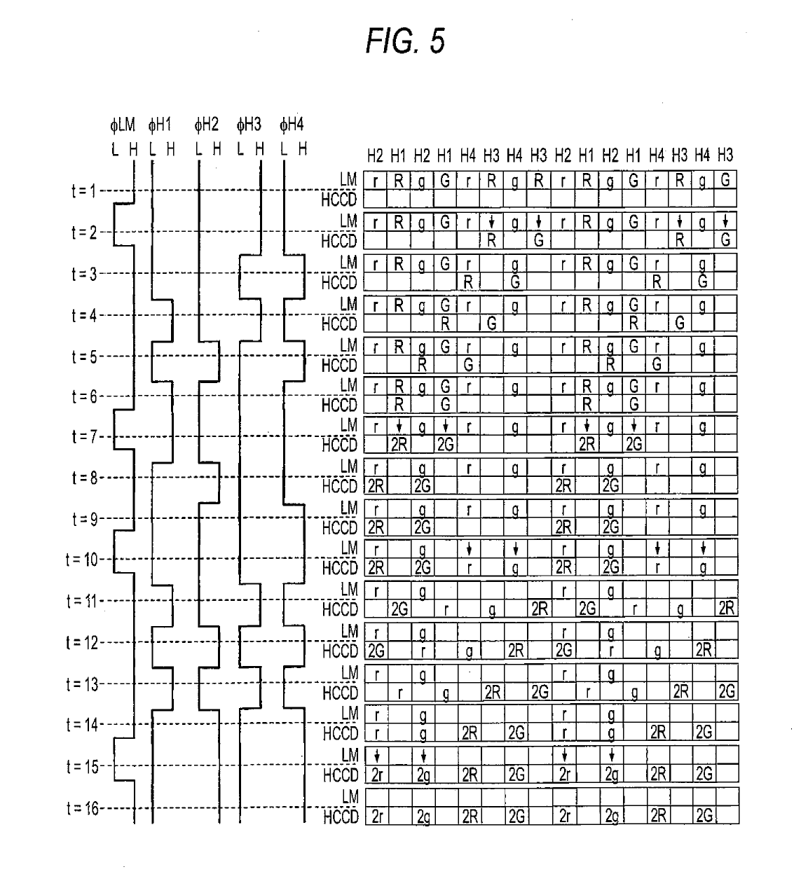

FIG. 5 is a diagram for explaining an operation when a user inputs a high-sensitive still image taking mode instruction from the operational part 33. In the moving image taking mode in FIG. 4, the signals detected by the r-pixel and the g-pixel and the b-pixel which constitute the second pixel group shown in the upper part in FIG. 6 are not output to heighten the frame rate. However, in the high-sensitive still image taking mode, also regarding the r-pixel and the g-pixel and the b-pixel, the pixel addition in the horizontal direction is performed and the added signals are output.

In this embodiment, the operations up to the time t=7 are the same as those in FIG. 4. However, in FIG. 4, the horizontal transfer pulse φH3 having no relation with transfer of the signal charge on the horizontal charge transfer path is changed from L to H at the time t=6; but in this embodiment, the horizontal transfer pulse φH3 is remained in the L-state.

After the pixel addition of the R-signal charge and the pixel addition of the G-signal charge have been performed at the time t=7, when the horizontal transfer pulses are changed at time t=8 as follows: φH1: H→L, φH2: L→H, φH3: L→L, and φH4: L→L, the added charges 2R and 2G on the horizontal charge transfer path are transferred to the output amplifier side by one electrode.

When the horizontal transfer pulses are changed at the next time t=9 as follows: φH1: L→L, φH2: H→L, φH3: L→L, and φH4: L→H, only the electric potentials under the electrodes H4 become low. Next, when the drive pulse of the line memory changes from H to L at time t=10, the r-signal charge and the g-signal charge flow from the line memory 105 at the positions, which are opposed to the electrodes H4, into the potential wells under the electrodes H4.

When the horizontal transfer pulses are changed at the next time t=11 as follows: φH1: L→H, φH2: L→L, φH3: L→H, and φH4: H→L, the signal charges on the horizontal charge transfer path are transferred to the output amplifier side by one electrode.

Hereafter, the horizontal transfer pulses φH1 to φH4 are changed as shown in FIG. 5, whereby the signal charges on the horizontal charge transfer path are transferred to the output amplifier side, and the r-signal charge and the g-signal charge in the horizontal charge transfer path are transferred to the positions of the H2 electrodes at time t=4.

When the drive pulse of the line memory 105 changes from H to L at the next time t=5, the r-signal charge and the g-signal charge on the line memory 105 flow into the potential wells under the horizontal electrodes H2, and 2-pixel addition of r-pixel and 2-pixel addition of g-pixel are performed, so that the signal charges on the horizontal charge transfer path become 2r, 2g, 2R and 2G.

Hereafter, the signal charges subjected to the pixel addition are transferred to the output amplifier side and outputted. In the pixel addition in FIG. 4, empty packets exist between potential packets (potential wells on the horizontal charge transfer path) of the signal charges subjected to the pixel addition. In this embodiment, since the 2r, 2g-signal charges are put into these empty packets and transferred, the same frame rate can be maintained without increasing drive frequency of the horizontal charge transfer path.

Though the drive method in FIG. 5 has been explained as the operation in the high-sensitive still image taking mode, the drive method in FIG. 5 may be executed in the moving image taking mode. Further, in the above description, the r-pixel, g-pixel, and b-pixel signal charges are read out by the vertical charge transfer path in the drive method of FIG. 4, and transferred to the line memory. However, the r-pixel, g-pixel, and b-pixel signal charges, without being read out by the vertical charge transfer path, may be discarded to the substrate side as they are.

Since a drive method of the CCD type solid-state imaging device according to an exemplary embodiment of the invention can perform the pixel addition readily and accurately at the high frame rate, it is effective to apply this drive method to the imaging apparatus such as a digital camera.

What is claimed is:

1. A method for driving a CCD solid-state imaging device that includes: a semiconductor substrate; a first pixel group including a plurality of pixels arranged in a square lattice in a surface part of the semiconductor substrate; a second pixel group including a plurality of pixels shifted in each of a row direction and a column direction of the square lattice by 2/1 of a pixel pitch with respect to the pixels in the first pixel group; color filters arranged in Bayer array with respect to each of the first pixel group and the second pixel group; a plurality of vertical transfer paths disposed in a serpentine way along pixel arrays, each pixel array including a plurality of pixels in the first pixel group and a plurality of pixels in the second pixel group; a horizontal charge transfer path disposed along ends in a charge transfer direction of the plurality of vertical transfer paths; and a line memory which is disposed between the ends in the charge transfer direction of the plurality of vertical transfer paths and the horizontal charge transfer path and which temporarily retains signal charges transferred by each of the plurality of vertical charge transfer paths and transfers the signal charges to the horizontal charge transfer path,
the method comprising adding signal charges, which are detected in two pixels in the first pixel group, in the horizontal charge transfer path and outputting the added signal charges, by means of a four-phase drive pulse of the horizontal charge transfer path and a drive pulse of the line memory, wherein the two pixels in the first pixel group are adjacent in a horizontal direction and correspond to color filters having the same color.

2. The method according to claim 1, wherein signal charges in the second pixel group are discarded.

3. The method according to claim 1, further comprising adding signal charges, which are detected two pixels in the second pixel group, in the horizontal charge transfer path and outputting the added signal charges, by means of the four-phase drive pulse of the horizontal charge transfer path and the drive pulse of the line memory, wherein the two pixels in the second pixel group are adjacent in the horizontal direction and correspond to color filters having the same color.

4. An imaging apparatus comprising:
a CCD solid-state imaging device that includes: a semiconductor substrate; a first pixel group including a plurality of pixels arranged in a square lattice in a surface part of the semiconductor substrate; a second pixel group including a plurality of pixels shifted in each of a row direction and a column direction of the square lattice by 2/1 of a pixel pitch with respect to the pixels in the first pixel group; color filters arranged in Bayer array with respect to each of the first pixel group and the second pixel group; a plurality of vertical transfer paths disposed in a serpentine way along pixel arrays, each pixel array including a plurality of pixels in the first pixel group and a plurality of pixels in the second pixel group; a horizontal charge transfer path disposed along ends in a charge transfer direction of the plurality of vertical transfer paths; and a line memory which is disposed between the ends in the charge transfer direction of the plurality of vertical transfer paths and the horizontal charge transfer path and which temporarily retains signal charges transferred by each of the plurality of vertical charge transfer paths and transfers the signal charges to the horizontal charge transfer path; and
a drive section that drives the CCD solid-state imaging device so that signal charges detected two pixels in the first pixel group are added in the horizontal charge transfer path and outputted, by means of a four-phase drive pulse of the horizontal charge transfer path and a drive pulse of the line memory, wherein the two pixels in the first pixel group are adjacent in a horizontal direction and correspond to color filters having the same color.

5. The imaging apparatus according to claim 4, wherein signal charges in the second pixel group are discarded.

6. The imaging apparatus according to claim 4, wherein the drive section drives the CCD solid-state imaging device so that: signal charges detected two pixels in the first pixel group are added in the horizontal charge transfer path and outputted, by means of a four-phase drive pulse of the horizontal charge transfer path and a drive pulse of the line memory, wherein the two pixels in the first pixel group are adjacent in a horizontal direction and correspond to color filters having the same color; and signal charges detected two pixels in the second pixel group are added in the horizontal charge transfer path and outputted, by means of the four-phase drive pulse of the horizontal charge transfer path and the drive pulse of the line memory, wherein the two pixels in the second pixel group are adjacent in the horizontal direction and correspond to color filters having the same color.
